(19) United States
(12) Patent Application Publication
(10) Pub. No.: US 2006/0209228 A1
(43) Pub. Date: Sep. 21, 2006

(54) Liquid crystal display device with LCD cover

(75) Inventor: Kazufumi Nishida, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/372,147

(22) Filed: Mar. 10, 2006

(30) Foreign Application Priority Data
Mar. 17, 2005 (JP) 2005-076494

(51) Int. Cl. G02F 1/1333

(52) U.S. Cl. 349/59

(57) ABSTRACT

The invention provides a liquid crystal display device with an LCD cover comprising: a conductive LCD cover for covering a rear surface of an LCD module for displaying information on a screen; and a circuit board mounted on the LCD cover; wherein a rear surface of the LCD cover is provided with an opening corresponding to the size of the circuit board, the circuit board mounted so as to cover the opening, and the distance between the rear surface of the LCD cover and the rear surface of the LCD module is set to at least an insulation distance corresponding to a voltage generated in a circuit formed on the circuit board.

The present application is based on and claims priority of Japanese patent application No. 2005-76494 filed on Mar. 17, 2005, the entire contents of which are hereby incorporated by reference.

### BACKGROUND OF THE INVENTION

1. Field of the Invention

The present invention relates to a liquid crystal display device with a thin body, such as a liquid crystal television or a liquid crystal monitor, being either installed at an area having narrow depth or hung on a wall, with an LCD (liquid crystal display) cover for covering the rear surface of an LCD module including a liquid crystal screen, a backlight, a reflector and the like.

2. Description of the Related Art

One conventional prior art structure for assembling a liquid crystal display device is disclosed for example in Japanese Patent Application Laid-Open Publication No. 5-103284 (patent document 1), which discloses an assembling structure of a liquid crystal television. According to the disclosed prior art, a reflector is sandwiched between a front cabinet and a rear cabinet, a liquid crystal panel is disposed between the front cabinet and the reflector, and a main substrate is disposed between the rear cabinet and the reflector, which are positioned using bosses provided at the opposing positions on the four corners of the front and rear cabinets and receiving seats, and integrally tightened by screws.

According to another prior art, a display screen 11 of an LCD module is disposed on a front face of a front cabinet 2 of a liquid crystal television 1 illustrated in FIG. 12, but since the LCD module is generally not designed to have circuit boards mounted thereto, an inverter circuit board 21 having a power supply circuit for lighting a backlight not shown in the LCD module 10 of FIG. 8 is disposed on a rear surface of an LCD cover 30 covering the rear surface 12 of the LCD module 10. A stepped recess 31 is formed on the rear surface of the LCD cover 30, and an opening 32 corresponding to the size of the circuit board 21 is formed in the recess 31 so as to prevent the circuits on the inverter circuit board 21 arranged thereto from being in contact with or approximating the rear surface of the LCD cover 30. The inverter circuit board 21 is mounted to cover the opening 32 and at a distance “a” from the LCD module 10 ensuring the insulation distance therebetween. In a specification shown in FIG. 12 in which a DVD (digital versatile disc) unit 5 is attached to the liquid crystal television 1, the DVD unit 5 is mounted on the rear surface of the stepped recess 31 and at a distance “b” from the inverter circuit board 21 ensuring the insulation distance therebetween.

Furthermore, according to FIG. 11 showing a state in which a front cabinet 2 and a rear cabinet 3 are mounted on an a-a cross-section shown in FIG. 10, the LCD cover 30 of the liquid crystal television 1 illustrated in FIGS. 9 through 11 cover the LCD module 10 at a distance “d” from the rear surface of the module 10, the LCD cover 30 having raised portions for mounting the inverter circuit board 21, the signal processing circuit board 22 and the input/output board 23 to which input/output terminals not illustrated are arranged, and the boards 21, 22 and 23 are mounted on support bases 34 so that they are positioned at a distance “a” from the rear surface of the LCD cover 30 ensuring the insulation distance. Thereafter, leg portions 35 provided on the LCD cover 30 are engaged via screws 50 on a front cabinet 2, so that the LCD cover is housed between the front cabinet 2 and the rear cabinet 3.

According to the prior art disclosed in patent document 1, the main substrate is sandwiched between the rear cabinet and the reflector using the bosses disposed on the four opposing corners of the front and rear cabinets and the receive seats for positioning and integrated via screws, according to which the size of the main substrate must be large enough to reach the four corners of the front and rear cabinets. Circuits of various frequencies such as digital circuits and analog circuits may be mixed and disposed on one large substrate, depending on the types of circuits formed on the main substrate, which may cause frequency interference.

According to another prior art mentioned earlier, by having the inverter circuit board 21 mounted on the opening of the stepped recess 31, the mounting height E of the inverter circuit board 21 can be reduced to the minimum height E=h+a obtained by adding the thickness h of the LCD module 10 and the distance “a” between the LCD module 10 and the inverter circuit board 21, but the depth H of the LCD cover 30 is the value obtained by adding the thickness h of the LCD module 10 and the distance “a” between the LCD module 10 and inverter circuit board 21 plus the thickness “c” of the inverter circuit board 21 and the distance “b” between the inverter circuit board 21 and the DVD unit 5 which corresponds to the depth of the stepped recess 31 within the stepped recess 31, or H=h+a+c+b, meaning that the depth c+b of the stepped recess 31 is added further. Furthermore, according to this arrangement, the mounting height D of the DVD unit 5 is D=h+a+c+b. If the DVD unit 5 is to be removed from the liquid crystal television 1 to create a liquid crystal television 1 for only displaying television broadcasts, the thickness of the liquid crystal television 1 becomes excessive since the LCD cover 30 housed in the body has increased depth H in which the depth c+b of the stepped recess 31 is added to the depth, which makes it difficult to reduce the thickness of the liquid crystal television 1. Moreover, since the LCD cover 30 must include the stepped recess 31 and the openings 32, the structure of molds for manufacturing the LCD cover 30 becomes complex and the costs for manufacturing the molds are increased.

Furthermore, according to the prior art shown in FIGS. 9 through 11, the LCD module 10 and the LCD cover 30 are assembled with a distance “d” formed therebetween, and the inverter circuit board 21, the signal processing circuit board 22 and the input/output board 23 are each mounted on support bases 34 raised from the rear surface of the LCD cover 30 so that they are mounted at a distance “a” ensuring the insulation distance from the LCD cover 30. It is possible to reduce the depth H of the LCD cover 30 to a value obtained by adding the thickness “h” of the LCD module 10 and the distance “d” between the LCD module 10 and the LCD cover 30 or H=h+d, but the mounting height E of the substrates 21, 22 and 23 is increased by having height “a” of the supporting bases 34 added to the depth H of the LCD cover 30 or E=h+d+a, so the thickness of the liquid crystal television 1 housing the above-mentioned LCD cover therein is increased by the length corresponding to distance “d” between the LCD module 10 and the LCD cover 30. Moreover, since the supporting bases 34 are formed by raising portions of the LCD cover 30, the structure of the mold for forming the LCD cover 30 becomes complex and the costs for manufacturing the molds are increased.

### SUMMARY OF THE INVENTION

In order to solve the prior art problems mentioned above, the present invention aims at providing a liquid crystal display device with an LCD cover capable of solving the problem of frequency interference caused by mounting digital circuits and analog circuits on a single large-sized main substrate, while minimizing the depth H of the LCD cover 30 and also minimizing the mounting height E of the boards 21, 22 and 23 mounted thereto, to thereby reduce the thickness of the liquid crystal display device housing the LCD cover and the boards, such as a liquid crystal television 1.

A first aspect of the invention provides a liquid crystal display device with an LCD cover comprising a conductive LCD cover for covering a rear surface of an LCD module for displaying information on a screen, and a circuit board mounted on the LCD cover, wherein a rear surface of the LCD cover is provided with an opening corresponding to the size of the circuit board, the circuit board mounted so as to cover the opening, and the distance between the rear surface of the LCD cover and the rear surface of the LCD module is set to at least an insulation distance corresponding to a voltage generated in a circuit formed on the circuit board.

According to the arrangement of aspect 1, the liquid crystal display device with an LCD cover includes a conductive LCD cover for covering the rear surface of an LCD module for displaying information on a screen, and a circuit board mounted on the LCD cover, wherein the rear surface of the LCD cover is provided with an opening corresponding to the size of the circuit board to be mounted thereto so as to prevent contact or approximation of the circuit formed on the circuit board with the LCD cover, and the circuit board is mounted so as to cover the opening. Further, the distance between the rear surface of the LCD cover and the rear surface of the LCD module at least ensures the insulation distance corresponding to the voltage generated in the circuit formed on the circuit board.

A second aspect of the present invention provides a liquid crystal display device with an LCD cover according to aspect 1, wherein the circuit board is divided into multiple circuit boards based on signal frequencies and functions of the circuits formed on the circuit board.

According to the second aspect of the invention, the circuit board is divided into multiple circuit boards based on signal frequencies and functions of the circuits formed on the circuit board, and mounted on the LCD cover.

A third aspect of the present invention provides a liquid crystal display device with an LCD cover according to aspect 1 or aspect 2, wherein the LCD cover is capable of having a stand fixing member attached thereto for fixing a stand for supporting the liquid crystal display device.

According to the arrangement of aspect 3, a stand fixing member for fixing a stand for supporting the liquid crystal display device can be attached to the LCD cover.

A fourth aspect of the present invention provides a liquid crystal display device with an LCD cover according to any one of aspects 1 through 3, wherein the LCD cover is capable of having a recording and reproducing unit such as a DVD unit attached thereto.

According to the arrangement of aspect 4, the LCD cover can have a recording and reproducing unit such as a DVD unit mounted thereto.

### BRIEF DESCRIPTION OF THE DRAWINGS

FIG. 1 is an explanatory cross-sectional side view showing an LCD cover covering an LCD module from the rear side thereof and a circuit board mounted thereon disposed in a liquid crystal television according to a preferred embodiment of the present invention;

FIG. 2 is an explanatory rear perspective showing the relative positional relationship between LCD module, LCD cover, openings, circuit boards and stand fixing members according to the present invention;

FIG. 3 is an explanatory rear view showing the state in which openings are formed to the LCD cover according to the present invention;

FIG. 4 is an explanatory rear view showing the state in which the circuit boards are mounted to cover the openings formed to the LCD cover according to the present invention;

FIG. 5 is an explanatory rear view showing the state in which a stand fixing member is disposed so as to arch over the input/output board mounted on the LCD cover according to the present invention;

FIG. 6 is an explanatory cross-sectional view showing the state in which the LCD cover is attached to the front cabinet and the rear cabinet is attached from the rear side thereof to house the LCD cover according to the present invention;

FIG. 7 is an explanatory cross-sectional side view showing the state in which the DVD unit is disposed to arch over the circuit board mounted on the LCD cover of the liquid crystal television according to the present invention;

FIG. 8 is an explanatory cross-sectional side view showing the stepped recess portion and the openings, and the circuit board and the DVD unit mounted thereto according to the prior art;

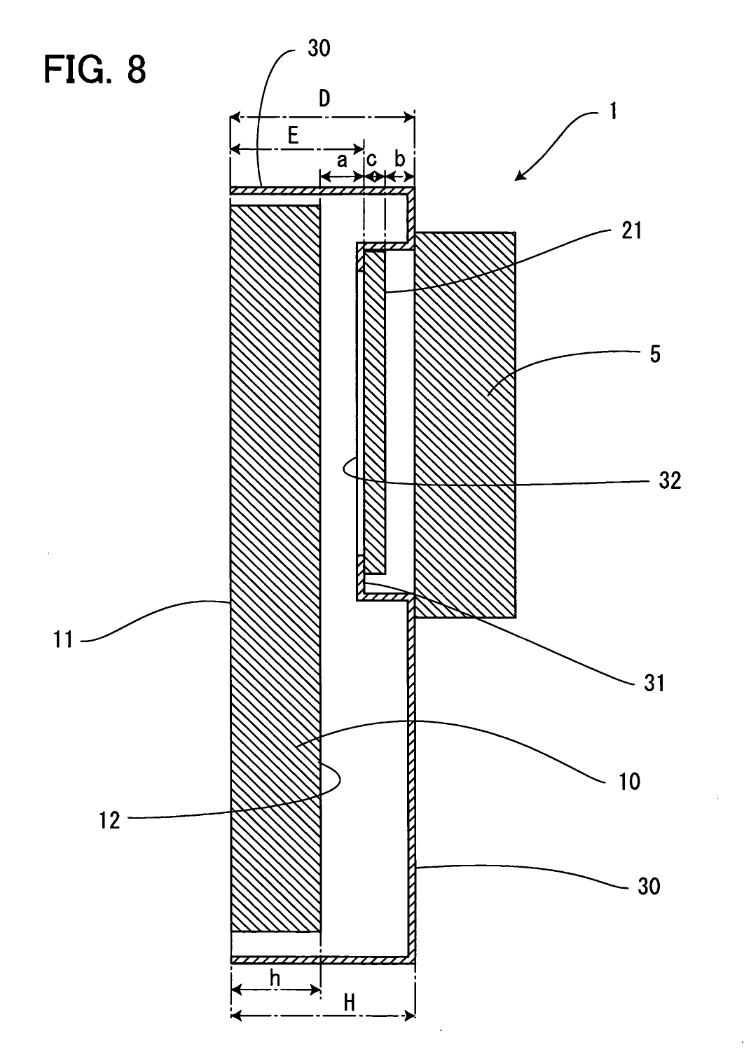

FIG. 9 is an explanatory rear view showing the state in which support bases are attached to the LCD cover according to the prior art;

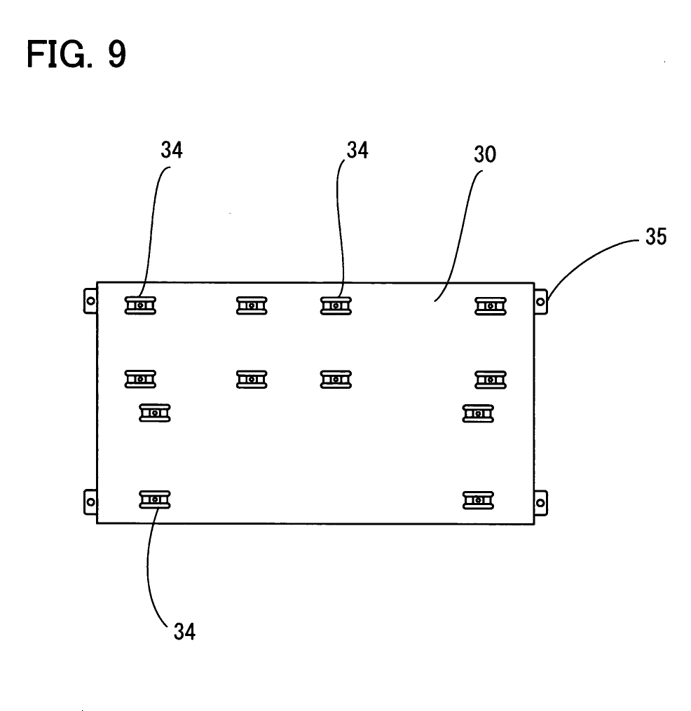

FIG. 10 is an explanatory rear view showing the state in which circuit boards are attached to support bases formed to the LCD cover according to the prior art;

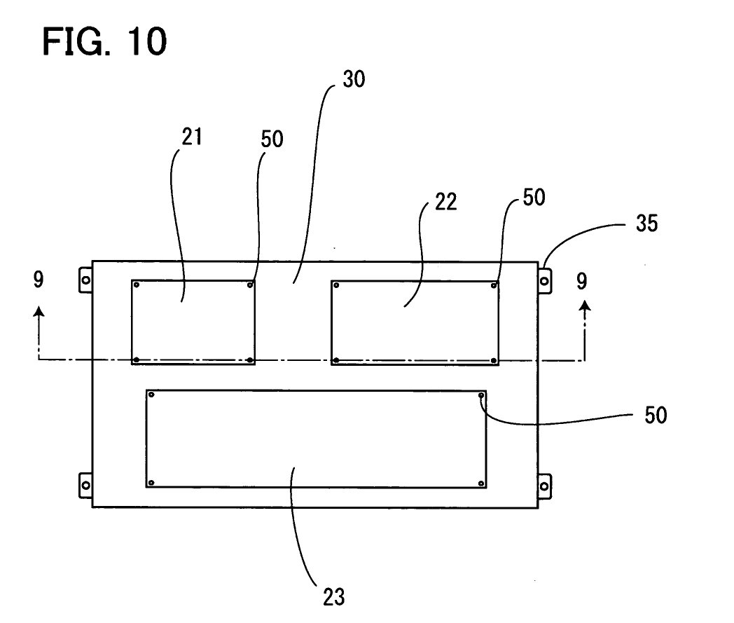

FIG. 11 is an explanatory cross-sectional view showing the state in which the LCD cover having the circuit boards mounted thereto via support bases is attached to the front cabinet and the rear cabinet is further attached to house the cover therein according to the prior art; and

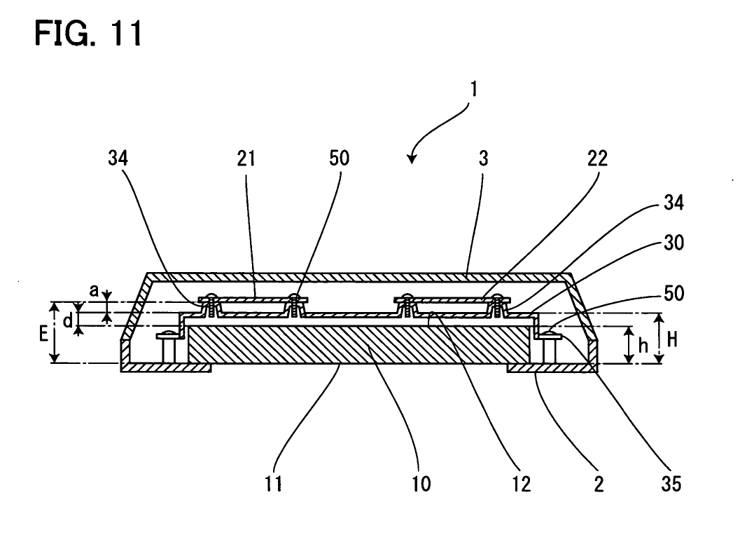

FIG. 12 is an explanatory perspective showing the exterior appearance of the liquid crystal television.

### DETAILED DESCRIPTION OF THE PREFERRED EMBODIMENTS

As described, the present invention relates to a liquid crystal display device with a thin body such as a liquid crystal television or an LCD monitor disposed in an area with a narrow depth or hung on a wall. The liquid crystal display device has a thin body realized by reducing the thickness of an LCD cover having circuit boards disposed on the rear surface thereof and covering a rear side of an LCD module including a display screen, a backlight, a reflector and so on. In the following description, the arrangement in which the circuit board is mounted on the LCD cover of the liquid crystal television without a built-in DVD unit and the arrangement of the liquid crystal television having a DVD unit mounted on the LCD cover are illustrated. The details of the examples are described hereafter.

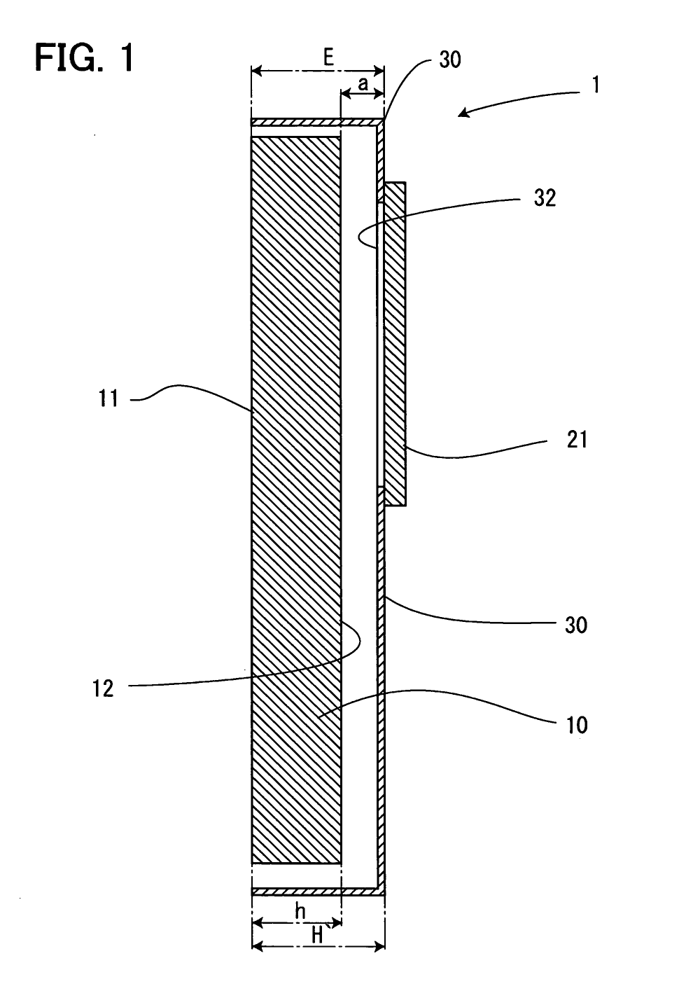

Preferred embodiments for carrying out the present invention are described hereafter with reference to FIGS. 1 through 7. Of course, the present invention can easily be applied to arrangements other than those illustrated in the examples within the scope of the invention.

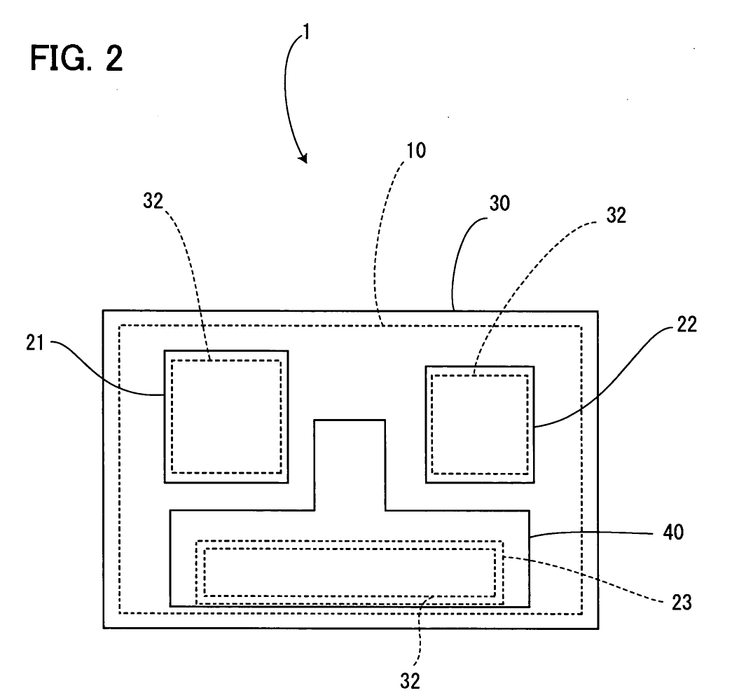

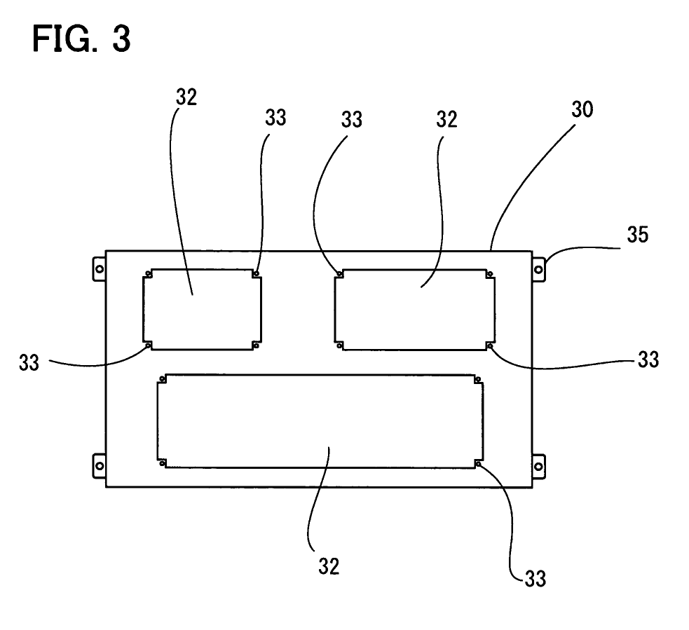

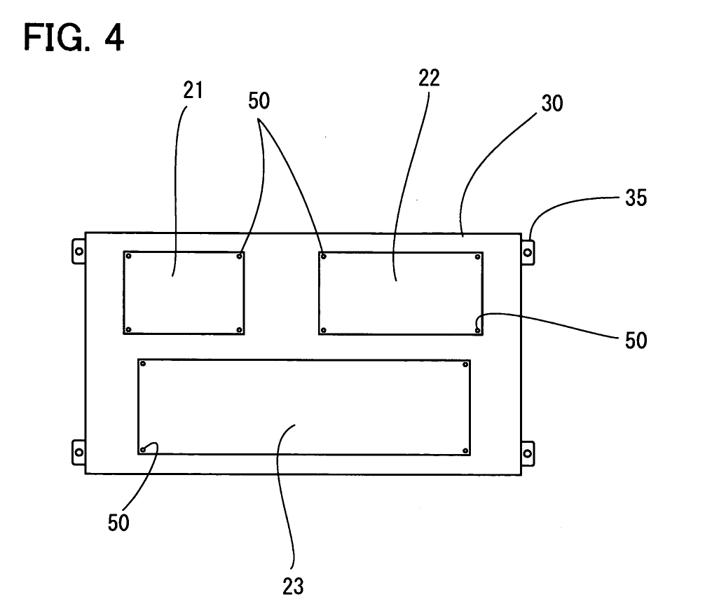

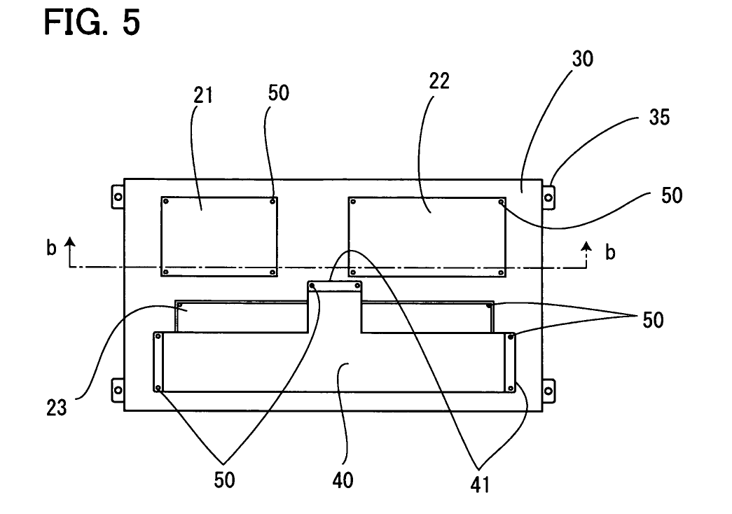

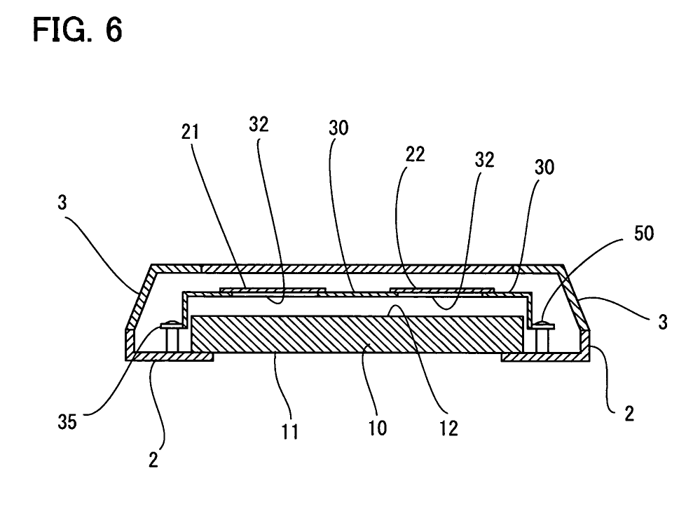

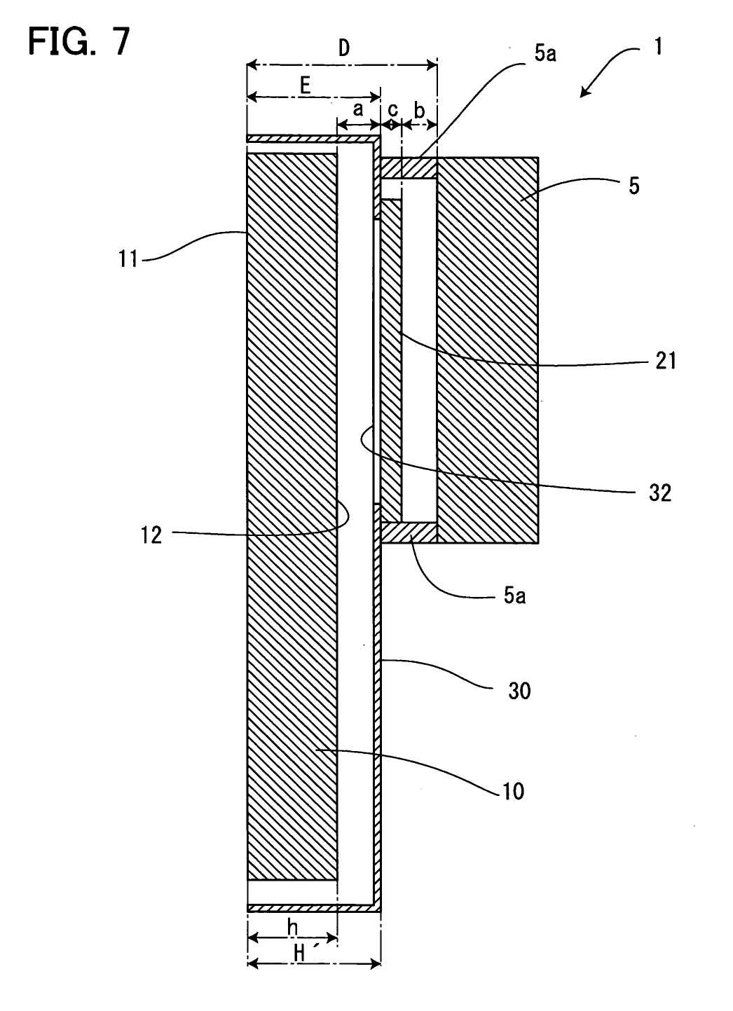

According to the present embodiment, FIG. 1 is a cross-sectional side view showing an LCD cover covering the rear side of an LCD module disposed in the interior of a liquid crystal television and a circuit board mounted on the LCD cover, and FIG. 2 is a rear view showing the relative positional relationship between the openings of the LCD cover, the circuit boards mounted thereto, and a stand fixing member. FIG. 3 is a rear view showing the openings formed to the OCD cover, and FIG. 4 is a rear view showing the circuit boards respectively mounted to cover the openings of the LCD cover. FIG. 5 is a rear view showing the state in which the stand fixing member is mounted to the LCD cover to which the circuit boards are attached, and FIG. 6 is a cross-sectional view showing the LCD module housed between a front cabinet and a rear cabinet, the LCD cover and the circuit boards. FIG. 7 is a cross-sectional side view showing the state in which a DVD unit is attached to the rear surface of the LCD cover illustrated in FIG. 1.

At first, with reference to the cross-sectional side view illustrated in FIG. 1, an LCD module 10 disposed in the interior of a liquid crystal television 1, an LCD cover 30 covering the rear surface 12 thereof, and an inverter circuit board 21 mounted to the cover are described. An LCD module 10 having a height greater than its width is arranged substantially at the center of FIG. 1, and on its left is a display screen 11 for displaying information and on its right is a rear surface 12 of the module 10. A liquid crystal panel, a backlight and a reflector not shown are layered and disposed inside the LCD module 10. A conductive LCD cover 30 which is a shallow box-shaped metal plate is disposed to cover the rear surface 12 side of the LCD module 10. Openings 32 are formed on the LCD cover 30 to prevent contact or approximation of the LCD cover 30 with the circuits formed on the circuit board 21 mounted thereto, wherein the inverter circuit board 21 is mounted to the cover so as to cover the openings 32 from the rear side thereof.

In FIG. 1, “h” represents the thickness of the LCD module 10 and H′ represents the depth of the LCD cover 30. Further, “a” represents the distance between the inverter circuit board 21 and the LCD module 10, which also is the distance that at least ensures an insulation distance corresponding to the high voltage generated in the inverter circuit board 21. Further, E represents the mounting height of the inverter circuit board 21. According to the example, the depth H′ of the LCD cover 30 can be expressed as H′=h+a, meaning that the depth H′ is the minimum necessary depth. Further, the mounting height E of the inverter circuit board 21 can also be expressed as E=h+a, meaning that the inverter circuit board 21 is disposed at the minimum necessary height E.

Next, with reference to FIG. 2, the relative positional relationships of the openings 32 on the LCD cover 30, the circuit boards 21, 22 and 23 mounted thereto and the stand fixing member 40 are described. Reference number 30 illustrated in FIG. 2 denotes the LCD cover mentioned earlier having a shallow box-like shape, which is arranged to cover the LCD module 10 from its rear side. The present liquid crystal television 1 receives power supply from an AC adapter not shown, so it does not have a power supply circuit board. Therefore, when seen from the rear side, the LCD cover 30 has an inverter circuit board 21 and a signal processing circuit board 22 on the upper left and right sides thereof, and a horizontally long input/output circuit board 23 at the lower side thereof, wherein a plurality of openings 32 are formed on positions corresponding to the circuit boards 21, 22 and 23, the size of each opening 32 corresponding respectively to the size of the circuit boards 21, 22 and 23. On the lower side of the LCD cover 30 is attached a stand fixing member 40 having rigidity that covers the input/output circuit board 23 from the rear side, by which the strength of the LCD cover 30 deteriorated by forming multiple openings 32 is compensated by attaching the rigid stand fixing member 40. Furthermore, the LCD cover 30 formed of the conductive material also functions as a ground (GND), so that the boards 21, 22 and 23 are easily grounded by simply mounting the same to the LCD cover 30.

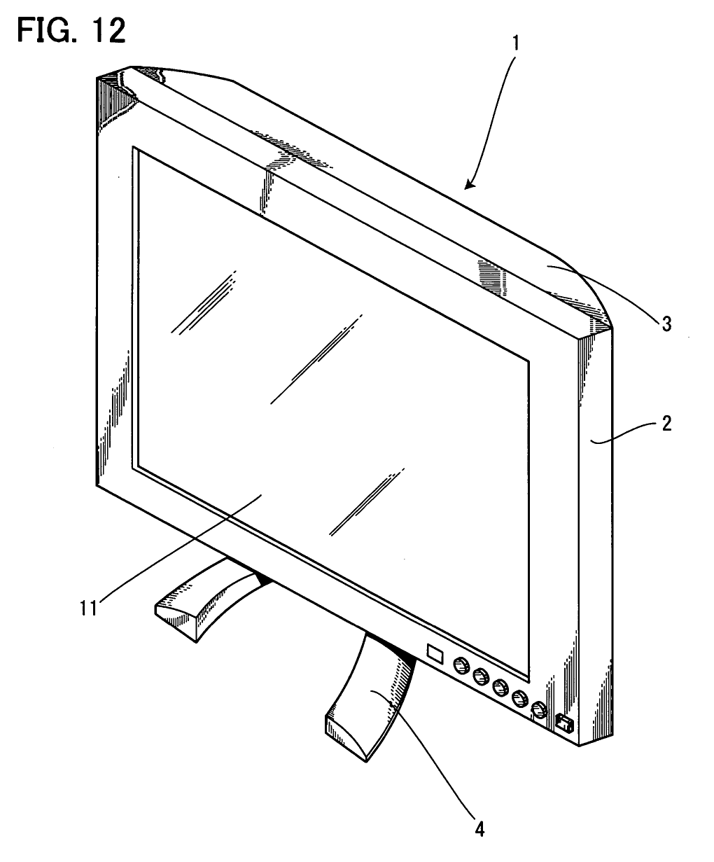

Next, with reference to FIGS. 3 through 6, the arrangement for mounting circuit boards 21, 22 and 23 to the LCD cover 30 will be described in detail. The LCD cover 30 illustrated in FIG. 3 has a substantially rectangular shallow box-like shape having leg portions 35 extended from left and right side walls and bent into an L-shape, and through the leg portions 35 the LCD cover 30 can be screw engaged via screws 50 to the inner side of a front cabinet 2 illustrated in FIG. 6 of the liquid crystal television 1 illustrated in FIG. 12. The bottom surface of the shallow box-shaped cover corresponds to the rear surface side of the Liquid crystal television 1, and the surface has plural openings 32 of substantially rectangular shapes formed thereto. Each opening 32 has a size and shape corresponding to the circuit boards 21, 22 and 23 to be mounted thereto, and on the four corners of each opening 32 are provided board supporting portions 33 projected toward the opening 32 and capable of supporting the corresponding circuit board by screw engagement not shown.

Next, the LCD cover 30 illustrated in FIG. 4 has the inverter circuit board 21, the signal processing circuit board 22 and the input/output circuit board 23 attached via screws 50 to the board supporting portions 33 formed to the LCD cover 30 corresponding to openings formed thereto.

Next, the LCD cover 30 illustrated in FIG. 5 has an inverter circuit board 21, a signal processing circuit board 22 and an input/output circuit board 23 engaged via screws 50 to the board supporting portions 33 as mentioned above, and a stand fixing member 40 with rigidity attached from behind the input/output circuit board 23 via screws 50 through engaging portions 41 extended from the ends thereof and bent in an L shape so that the stand fixing member 40 maintains a distance from the surface of the input/output circuit board 23.

Next, the LCD module 10 and the LCD cover 30 having multiple boards mounted thereto disposed between the front cabinet 2 and the rear cabinet 3 are described with reference to the cross-sectional view of FIG. 6. FIG. 6 is a b-b cross-section of FIG. 5, showing the state in which the front cabinet 2 and the rear cabinet 3 are mounted. The inverter circuit board 21 and the signal processing circuit board 22 are disposed so as to cover the openings 32 on the LCD cover 30 covering the rear surface 12 of the LCD module 10, and the LCD cover 30 has its substantially L-shaped leg portions 35 extended from the side walls engaged to the inner side of the front cabinet 2 via screws 50. Moreover, the LCD module 10 and the LCD cover 30 covering the rear surface 12 of the module and having circuit boards 21 and 22 mounted thereto are housed between the front cabinet 2 and the rear cabinet 3.

Next, an example in which a DVD unit 5 is disposed on the LCD cover 30 of FIG. 1 is described with reference to FIG. 7. In FIG. 7, the LCD module 10 has an LCD cover 30 with an inverter circuit board 21 arranged to cover an opening 32 from the rear surface 12 side thereof, and the DVD unit 5 is supported on the rear side of the LCD cover 30 via a mounting member 5a provided on the LCD cover 30 so as to arch over the inverter circuit board 21.

In FIG. 7, the depth H′ of the LCD cover 30 is the length obtained by adding the thickness “h” of the LCD module 10 and the distance “a” which ensures the required insulation distance corresponding to the high voltage of the inverter circuit board 21, which can be expressed as H′=h+a. Similarly, the mounting height E of the inverter circuit board 21 is E=h+a. The mounting height D of the DVD unit 5 mounted on the LCD cover 30 is the length obtained by adding thickness “c” of the inverter circuit board 21 and the distance “b” ensuring the required insulation distance corresponding to the high voltage of the inverter circuit board 21 to the aforementioned depth H′, which can be expressed as D=h+a+c+b. Accordingly, the mounting member 5a for mounting the DVD unit 5 is set to a length of 5a=c+b.

According to the embodiment disclosed above, the liquid crystal television 1 comprising an LCD cover 30 is a liquid crystal display device having a conductive LCD cover 30 for covering the rear surface 12 side of an LCD module 10 for displaying information on a display screen 11, the LCD cover 30 having circuit boards 21, 22 and 23 mounted thereto, the rear surface of the LCD cover 30 having openings 32 corresponding to the size of circuit boards 21, 22 and 23, respectively, to prevent contact or approximation of the circuits formed on the circuit boards 21, 22 and 23 with the LCD cover 30, the circuit boards 21, 22 and 23 being mounted so as to cover the openings 32. Further, the distance “a” between the rear surface of the LCD cover 30 and the rear surface 12 of the LCD module 10 is set to a distance at least ensuring the insulation distance of the voltage generated to the circuits formed to the circuit boards 21, 22 and 23, by which the depth H′ of the LCD cover 30 is set to a length obtained by adding thickness “h” of the LCD module 10 and the distance “a” between the LCD cover 30 and the LCD module 10, or H′=h+a, which is the minimum necessary height for mounting the circuit boards 21, 22 and 23 to the rear surface of the LCD cover 30. Accordingly, the mounting height E of the circuit boards 21, 22 and 23 mounted to the LCD cover 30 can be mounted at the minimum necessary height, or E=h+a. According to this embodiment, the liquid crystal television 1 is capable of having a thin body with minimized thickness determined by adding the height of electronic components not shown mounted on circuit boards 21, 22 and 23 mounted at the minimum necessary height E. As described, the circuit board mounting structure for mounting circuit boards 21, 22 and 23 to the rear surface side of the LCD cover 30 can be simplified in which the circuit boards 21, 22 and 23 are mounted to openings 32 formed to the LCD cover 30 via screws 50. Moreover, since the LCD cover 30 is made of conductive material and thus functions as ground, the circuit boards 21, 22 and 23 can be ground-connected by simply mounting the same on the LCD cover 30. Accordingly, the mounting operation of the circuit boards 21, 22 and 23 are facilitated and no additional components for mounting the circuit boards 21, 22 and 23 are necessary, so the number of components is not increased. Furthermore, the LCD cover 30 merely having openings 32 and screw holes can be formed using simple molds, so the costs for manufacturing molds are suppressed. Thus, the costs for manufacturing the liquid crystal television 1 can be suppressed.

Furthermore, since the circuits on the circuit boards 21, 22 and 23 having various signal frequencies and functions are divided and mounted to the multiple circuit boards 21, 22 and 23, the liquid crystal television for receiving digital broadcasts or the liquid crystal television 1 having a built-in DVD unit 5 for recording and reproducing data on an optical disk not shown or an HDD unit enables to suppress the frequency interference between the signal processing circuit board 22 for processing video audio signals which are high-frequency digital signals, the inverter circuit board 21 having a power circuit for lighting a backlight not shown in the LCD module 10, and the input/output circuit board 23 connected to external devices and processing various signals.

The LCD cover 30 can have a stand fixing member 40 attached thereto for fixing the stand 4 for supporting the liquid crystal television 1, and the deteriorated strength of the LCD cover 30 caused by the increased number of openings 32 can be compensated by attaching the rigid stand fixing member 40.

Since the LCD cover 30 is designed to have a recording and reproducing unit such as a DVD unit 5 attached thereto, the DVD unit 5 or other recording and reproducing units can be easily attached to the LCD cover 30 and a composite machine including a liquid crystal display device and a recording and reproducing apparatus such as the liquid crystal television 1 having a built-in DVD unit 5 or other recording and reproducing apparatus can be obtained.

The preferred embodiments of the present invention have been described in detail, but various modifications are enabled within the scope of the present invention. For example, the liquid crystal display device is not restricted to the liquid crystal television 1, but can be any device capable of displaying information on a liquid crystal display, such as composite devices including DVD devices, HDD (hard disk drive) devices or VTR (videotape recorder) devices and the like, or liquid crystal monitors used for example in personal computers, cellular phones and security systems such as interphones and monitor cameras. Moreover, the circuit boards of the present device are not restricted to the inverter circuit board 21, the signal processing circuit board 22 and the input/output circuit board 23 in the embodiments, and various changes can be made such as adding a power supply circuit board to supply power to the device, or changing the number and functions of the circuit boards to correspond to the application.

The effects of the present invention are as follows.

According to the first aspect of the present invention, the liquid crystal display device with an LCD cover comprises a conductive LCD cover for covering a rear surface of an LCD module for displaying information on a screen, and a circuit board mounted on the LCD cover, wherein a rear surface of the LCD cover is provided with an opening corresponding to the size of the circuit board, the circuit board mounted so as to cover the opening in order to prevent the circuits formed on the circuit boards mounted on the LCD cover from being in contact with or approximating the LCD cover, and the distance between the rear surface of the LCD cover and the rear surface of the LCD module is set to at least an insulation distance corresponding to a voltage generated in a circuit formed on the circuit board. According to this arrangement, the depth of the LCD cover can be the minimum required depth for mounting circuit boards on the rear surface of the LCD cover, which is the length obtained by adding the thickness of the LCD module and the distance ensuring the insulation distance between the LCD cover and the LCD module. Accordingly, the mounting height of the circuit board attached to the LCD module can similarly be the minimum necessary height. Thus, the thickness of the liquid crystal display device can be narrowed down to a depth achieved by adding the height of the electronic components mounted on the circuit boards which are mounted at the minimum necessary height. The mounting structure for mounting circuit boards on the LCD cover is simplified, according to which the circuit boards are merely positioned over the opening portions formed to the LCD cover and fixed thereto via screws. According to this arrangement, the mounting operation of the circuit boards becomes facilitated, and no additional components are necessary for mounting the circuit boards. Further, since the LCD cover only requires openings and screw holes to be formed thereto, the mold structure for forming the LCD cover is simplified, and the costs for manufacturing molds are cut down. Thus, the manufacturing costs of the liquid crystal display device can be cut down.

According to the second aspect of the present invention, the circuit board is divided into multiple circuit boards based on signal frequencies and functions of the circuits formed on the circuit board and mounted on the LCD cover, thereby preventing circuits having different frequencies from being formed on a single circuit board. Therefore, the present arrangement enables to prevent occurrence of frequency interference within the circuit board.

According to the third aspect of the present invention, the LCD cover is capable of having a stand fixing member attached thereto for fixing a stand for supporting the liquid crystal display device. Thus, the rigidity of the LCD cover being deteriorated by increasing the openings can be compensated by attaching a rigid stand fixing member to the LCD cover.

According to the fourth aspect of the present invention, the LCD cover is capable of having a recording and reproducing unit such as a DVD unit attached thereto, so that a composite machine of a liquid crystal display and a recording and reproducing apparatus, such as a liquid crystal television with a built-in recording and reproducing unit, can be obtained.

1. A liquid crystal display device with an LCD cover comprising:
a conductive LCD cover for covering a rear surface of an LCD module for displaying information on a screen; and
a circuit board mounted on the LCD cover; wherein
a rear surface of the LCD cover is provided with an opening corresponding to the size of the circuit board, the circuit board mounted so as to cover the opening, and the distance between the rear surface of the LCD cover and the rear surface of the LCD module is set to at least an insulation distance corresponding to a voltage generated in a circuit formed on the circuit board.

2. The liquid crystal display device with an LCD cover according to claim 1, wherein
the circuit board is divided into multiple circuit boards based on signal frequencies and functions of the circuits formed on the circuit board, and mounted on the LCD cover.

3. The liquid crystal display device with an LCD cover according to claim 1, wherein
the LCD cover is capable of having a stand fixing member attached thereto for fixing a stand for supporting the liquid crystal display device.

4. The liquid crystal display device with an LCD cover according to claim 1, wherein
the LCD cover is capable of having a recording and reproducing unit such as a DVD unit attached thereto.

5. The liquid crystal display device with an LCD cover according to claim 2, wherein
the LCD cover is capable of having a stand fixing member attached thereto for fixing a stand for supporting the liquid crystal display device.

6. The liquid crystal display device with an LCD cover according to claim 2, wherein
the LCD cover is capable of having a recording and reproducing unit such as a DVD unit attached thereto.

7. The liquid crystal display device with an LCD cover according to claim 3, wherein
the LCD cover is capable of having a recording and reproducing unit such as a DVD unit attached thereto.

8. The liquid crystal display device with an LCD cover according to claim 5, wherein
the LCD cover is capable of having a recording and reproducing unit such as a DVD unit attached thereto.
